(19) United States
(12) Patent Application Publication
(10) Pub. No.: US 2026/0103419 A1
(43) Pub. Date: Apr. 16, 2026

(54) GLASS PANE AND ASSEMBLY OF GLASS PANES WITH LOW DEGREE OF FINE WAIVENESS, AND METHODS FOR PRODUCING AND USING SAME

(71) Applicant: SCHOTT Technical Glass Solutions GmbH, Jena (DE)

(72) Inventors: Juliane Brandt-Slowik, Jena (DE); Thomas Schmiady, Jena (DE); Stefan Eberl, Jena (DE); Andreas Sprenger, Jena (DE); Armin Vogl, Jena (DE); Michael Meister, Mainz (DE); Tommy Schröder, Jena (DE); Michael Reinl, Jena (DE)

(73) Assignee: SCHOTT Technical Glass Solutions GmbH, Jena (DE)

(21) Appl. No.: 19/116,553

(22) PCT Filed: Sep. 27, 2023
(86) PCT No.: PCT/EP2023/076685

§ 371 Date: Mar. 28, 2025

(30) Foreign Application Priority Data
Sep. 28, 2022 (DE) 10 2022 125 049.0
Nov. 10, 2022 (DE) 10 2022 129 719.5
Sep. 27, 2023 (WO) PCT/EP2023076685

(51) Int. Cl. C03B 18/04; C03C 3/091

(52) U.S. Cl. CPC C03B 18/04; C03C 3/091

(57) ABSTRACT

The invention relates to a glass pane, in particular a glass pane which is obtained by individualizing a floated glass strip formed by a hot forming process, in particular comprising a borosilicate glass, with a thickness (D) ranging from at least 1.75 mm to maximally 7 mm or a thickness (D) ranging from at least 0.7 mm to 7 mm, in particular from 1.1 mm to maximally 7 mm, and comprising an upper face and a lower face. The glass pane is characterized by a fine waviness of 10 nm to 26 nm, preferably between 10 nm and 15 nm, in at least one direction parallel to the surface of the glass pane on at least one surface of the upper face or the lower face of the glass pane. The invention also relates to an assembly of said glass panes and to methods for producing and using same.

### CROSS-REFERENCE TO RELATED APPLICATIONS

This application is a national stage entry under 35 U.S.C. § 371 of International Patent Application No. PCT/EP2023/076685 entitled “GLASS PANE AND ASSEMBLY OF GLASS PANES WITH LOW DEGREE OF FINE WAVINESS, AND METHODS FOR PRODUCING AND USING SAME” filed Sep. 27, 2023, which is incorporated in its entirety herein by reference. International Patent Application No. PCT/EP2023/076685 claims priority to German Patent Application No. 10 2022 125 049.0 filed on Sep. 28, 2022, and German Patent Application No. 10 2022 129 719.5 filed on Nov. 10, 2022, which are both incorporated in their entirety herein by reference.

### BACKGROUND OF THE INVENTION

### Field of the Invention

The present application relates to a float glass sheet, preferably a glass sheet with few optical defects, more particularly little fine waviness, to a set of float glass sheets, to a method for producing same, and to the use thereof.

### DESCRIPTION OF THE RELATED ART

Glass sheets may be employed in diverse applications—for example, in vehicle glazing, in architectural applications, or as covers for electronic devices (referred to as display glass).

For example, German patent application DE 10 2007 025 687 B3 describes the use of a borosilicate glass sheet in a flat glass display apparatus, and also a flat glass display apparatus equipped in this way.

International patent application WO 2018/114956 A1 describes a thin glass substrate and also a method and an apparatus for producing same. In the method for producing the thin glass substrate, the viscosity of the glass is adjusted in a targeted way.

International patent application WO 2019/076492 A1 also describes a thin glass substrate, more particularly a thin borosilicate glass substrate, and a method and an apparatus for producing same, where here as well the viscosity of the glass is adjusted in a targeted way in the production method.

Finally, German laid-open specification DE 10 2020 104 973 A1 describes a glass substrate for a vehicle glazing, more particularly for the windshield of a vehicle. For this purpose, the aging rate of the glass is adjusted in a targeted way.

Documents WO 2021/216362 A1 and WO 2021/222161 A1 describe liquid-crystal cells which comprise substrates of low waviness, produced with a fusion draw method. WO 2022/115280 A1 discusses substrates for micro-LEDs and also for the transfer of microelectronics and discloses substrates of low waviness, produced with a fusion draw method. None of these three documents reveals reproducible technical teaching as to how these substrates are actually produced. Each of these substrates does not comprise float glass sheets, meaning no glass sheets produced with a float method.

US 2002/0012160 A1 discloses a glass substrate for a display, produced by a float method. A value W_{CA} (filtered center line waviness, corresponding to JIS B0651) of 0.03 to 0.5 μm, ascertained with a surface roughness measuring instrument with a phase-compensated 2RC zone filter with limiting values of 0.8 to 25 mm over a measuring length of 200 mm, is specified. Glass substrates having relatively low center line wavinesses are obtained by surface working measures, such as polishing, for example. However, these low center line wavinesses obtained by surface working are said to be little suited to display applications, owing to electrostatic charging.

Prior-art glass sheets therefore generally still have rather pronounced optical defects, especially lens-like defects, which may result, for example, from a rather high fine waviness, and require further working by surface working measures, such as polishing, for example.

There is therefore a need for methods for producing glass sheets that enable a further reduction in optical defects, especially fine wavinesses, and for glass sheets having preferably minimal optical defects, especially little fine waviness, which in particular require no further surface working.

### SUMMARY OF THE INVENTION

An object of the invention lies in the provision of a glass sheet which at least partly diminishes the above-described disadvantages of the prior art. A further aspect lies in the provision of a method for producing such glass sheets and also in the use of these glass sheets.

With a glass sheet, more particularly as contemplated in the context of the present disclosure, and thus with a glass sheet obtained by a hot forming process which comprises floating, said glass sheet having substantially parallel principal surfaces, the beam path of light passing through these surfaces may be deflected, causing at least part of this light to change its direction of propagation. This deflection may arise through deviations on the part of the surface of the glass sheet from an ideal planar surface. As a result, instead of the ideal case of only a merely parallel displacement of the beam path of this light perpendicular to its direction of propagation, in the case, for example, of the passage of the light through the glass sheet being inclined relative to the glass sheet, different kinds of deflection of the beam path may occur.

Roughness of at least one of the surfaces of the glass sheet may cause irregular scattered light which, when viewed through such a glass sheet, leads substantially merely to a reduction in the contrast of articles lying behind the glass sheet—that is, on the side of the glass sheet facing away from the viewer.

Where, however, the glass sheet has not only irregular and thus randomly fluctuating surface structures but has a wavy surface and thus has periodic elevations extending spatially at least in one direction, this may give rise to perturbations which may alter, and more particularly distort, the image of articles lying behind the glass sheet when viewed through the glass sheet. These image-altering periodic perturbations of the beam path are presently also referred to as optical defects and may be detected, for example, as wavinesses in the surface of the glass sheet. Distortions of these kinds may be particularly disruptive in the case, for example, of the viewing of a display or indication apparatus which uses a glass sheet as its cover sheet, for example.

One aspect of the present invention is intended in particular to also alleviate these image-altering structures on at least one of the surfaces of the glass sheet, but preferably on the surface of the top side of the glass sheet and on the surface of the bottom side of the glass sheet too, and more particularly to do so without any need for surface working measures to be taken, such as polishing, for example.

The invention successfully provides a surprisingly effective way of reducing optical defects directly, during the actual hot forming of a glass sheet, without requiring subsequent surface working of the respective glass sheet. The fine waviness values reported in the claims and also in the present description and the figures therefore relate in each case to a hot-formed glass sheet immediately after its withdrawal from the float bath, and in particular to a glass sheet obtained by singulation from a float glass ribbon shaped by means of hot forming in accordance with the invention but having undergone surface working-more particularly surface-altering measures which have a measurable influence on the fine waviness-neither during the hot forming nor after the hot forming.

The periodic elevations extending spatially at least in one direction on the surface of at least one side of the glass sheet are also referred to, in accordance with standard practice, as waviness in the context of the present disclosure, and may be measured, for example, by profilometry with a multiplicity of commercially available instruments known to the skilled person.

Since the present disclosure, however, addresses not just any wavinesses but rather specific forms of the waviness within a defined spatial spectrum extending in one spatial direction, preferably perpendicular to the drawing direction, the present disclosure is also delimited from just any form of waviness through the use of the concept of fine waviness. The measured detection of this fine waviness is described in more detail below.

The fine waviness was determined presently by measuring the surface of the glass sheet using a ZEISS Surfcom 1400-350 surface and contour measuring instrument (with the release P000083259) along a direction perpendicular to the drawing direction Y and thus running in the X-direction on the surface of the top side and the surface of the bottom side of the respective glass sheet within a measurement area M1 to M8 and also M1′ to M8′. The aforementioned X-direction can be seen, for example, in the Cartesian coordinate system represented in FIGS. 1 to 4. A lower cut-off wavelength λc was chosen at 0.25 mm and an upper cut-off wavelength λf of 8 mm. Filtering took place using a Gaussian filter. The fine waviness values output by this contour measuring instrument are also referred to in the manner customary in the art as Wfpd values and are also output thus referenced by said measuring instrument.

The unfiltered primary profile (P-profile), being the surface profile actually measured, may be filtered, in particular according to DIN EN ISO 11562/DIN EN ISO 16610-21, for conversion into the waviness profile (W-profile) and the roughness profile (R-profile), with the determining parameter for the boundary between waviness and roughness and hence the lower cut-off wavelength λc chosen being at 0.25 mm, one particular reason for this being not to allow the results of the present measurement to be influenced by the aforementioned roughness components which lead only to an irregularly, randomly distributed deflection of light passing through the glass sheet.

The upper cut-off wavelength λf chosen was 8 mm, so that the present measurement does not also detect wavinesses essentially no longer of interest for the application of the present invention, as wavinesses with a wavelength of more than 8 mm are manifested as optical defects only to a very low extent for the use of the glasses of the invention.

The measurement data presently obtained have been reported in accordance with EN ISO 4287:1998, which specifies the geometric product specifications (GPS) of the surface quality. The wavinesses measured within these cut-off wavelengths from λc=0.25 mm to λf=8 mm are referred to as fine wavinesses in the context of the present disclosure and are reported with their respective values in line with the standard.

The present invention relates to a glass sheet, more particularly a glass sheet comprising a borosilicate glass or composed of a borosilicate glass, having a thickness of between at least 1.75 mm and at most 7 mm or having a thickness of between 0.7 mm and at most 7 mm, more particularly between 1.1 mm and at most 7 mm. The glass sheet comprises a top side and a bottom side, which each define one surface of the glass sheet, with these surfaces extending substantially parallel to one another. The thickness D of the glass sheet 33, 33′, 33″ hot-formed by means of floating is the distance of the upper surface, thus the top side, to the lower surface, thus the bottom side, as also represented for example in FIG. 4 for the hot-formed glass ribbon 13 from which the glass sheets 33, 33′, 33″ are singulated.

The invention according to a first aspect provides a glass sheet, more particularly a glass sheet obtained by singulation from a float glass ribbon shaped by means of hot forming, more particularly comprising a borosilicate glass, having a thickness D of between at least 1.75 mm and at most 7 mm or having a thickness D of between at least 0.7 mm and at most 7 mm, more particularly between 1.1 mm and at most 7 mm, comprising a top side and a bottom side, characterized by a fine waviness on at least one surface of the top side or bottom side of the glass sheet of 10 nm to 26 nm, preferably between 10 nm and 15 nm, in at least one direction parallel to the surface of the glass sheet.

The fine waviness here for example on the surface of the top side or the surface of the bottom side of the glass sheet is measured along a line ML having a length of 260 mm, preferably within a square area M1 to M8 and also M1′ to M8′ of 260 mm times 260 mm and is between at least 10 nm to 26 nm, preferably between 10 nm and 15 nm. As can be seen for example from FIGS. 7a and 7b, the measurement areas M1 to M8 and M1′ to M8′ may also be situated on a single coherent region of the glass ribbon 13, more particularly on a single glass sheet 33, 33′, 33″ singulated from said ribbon, in which case the presently disclosed properties are also valid for singulated glass sheets 33, 33′, 33″ which have an extent in the X-direction that is greater than the length of an individual one of the measurement areas M1 to M8 and M1′ to M8′.

The aforementioned at least one direction corresponded in each case to the X-direction of the Cartesian coordinate system represented in FIGS. 1 to 4 and therefore ran perpendicularly to the drawing direction Y used in the hot forming, each of which also indicates the distance from a component to the throughput regulator, the tweel or control slider, with the side of the tweel or control slider facing the float bath being situated, as represented in FIG. 5, at a location in the drawing direction Y at a distance of zero m and therefore representing the starting point for indications of distance, which are each indicated for the midpoint Mi of the float bath in respect of the X-direction.

This at least one direction may be indicated on the glass sheet or on packaging of the glass sheet, in order to ensure extremely simple further processing of the glass sheet. Alternatively, this at least one direction may also be ascertained independently of any indication of the at least one direction, in particular independently of the indication “perpendicular to the drawing direction”, by measurement of the respective direction having the fewest fine wavinesses.

One preferred embodiment also relates to a set of glass sheets comprising a multiplicity of glass sheets, more particularly at least eight glass sheets, as claimed in the claims from 1 to 4, wherein the median of the fine wavinesses of the set has a value which is less than 20 nm. As can be seen from FIGS. 7a and 7b, for example, the set of glass sheets may comprise glass sheets 33, 33′, 33″, wherein all or at least more than one of the measurement areas M1 to M8 and M1′ to M8′ are situated on a single coherent region of the glass ribbon 13, in that case more particularly on more than one single glass sheet 33, 33′, 33″ singulated from said ribbon. One of the singulated glass sheets of the set here may also have an extent in the X-direction that is greater than that of one of the measurement areas M1 to M8 and M1′ to M8′.

In other words, the present disclosure therefore provides a glass sheet which has particularly minimal optical defects that may be caused in particular by fine wavinesses.

This kind of achievement was not hitherto known. The low level of fine waviness of the glass sheet according to the present application, however, is particularly advantageous especially for applications of the glass sheet, for example, in electronic devices and displays, where it may be used as a cover sheet. For glazing uses as well, especially as architectural glazing, the glass sheets of the invention have advantageous suitability.

It is additionally advantageous, especially with regard to the scratch resistance and the chemical stability of the glass sheet, if it comprises a borosilicate glass comprising the following components in % by weight:

| | |
|---|---|
| SiO₂ | 70 to 87, preferably 75 to 85 |
| B₂O₃ | 5 to 25, preferably 7 to 14 |
| Al₂O₃ | 0 to 5, preferably 1 to 4 |
| Na₂O | 0.5 to 9, preferably 0.5 to 6.5 |
| K₂O | 0 to 3, preferably 0.3 to 2.0 |
| CaO | 0 to 3 |
| MgO | 0 to 2. |

With a borosilicate glass of this kind, particularly good scratch resistance and chemical integrities are realized. It is also possible in this way to obtain glasses having only a low coefficient of thermal expansion. The coefficient of linear thermal expansion in the range between 20° C. and 300° C. is preferably less than 5*10⁻⁶/K, but preferably at least 3.0*10⁻⁶/K.

According to one embodiment, the glass sheet is configured more preferably as a float glass sheet. It is possible with preference in this way to provide a particularly minimal fine waviness.

A glass sheet of this kind may advantageously be produced in a method according to a further aspect of the present disclosure. The present disclosure therefore also relates to a method for producing a glass sheet, more particularly a method for continuously producing a glass sheet, more particularly a glass sheet according to one embodiment, comprising the steps of
providing a batch comprising glass raw materials,
melting the batch to give a glass melt,
adjusting the viscosity of the glass melt,
transferring the glass melt to an apparatus for hot forming by means of floating to form a glass ribbon,
singulating the hot-formed glass ribbon to give a glass sheet,
   wherein the viscosity in the apparatus for hot forming is adjusted such that the sum total of the common logarithms at the distance from a component for throughput regulation at which the glass after impinging on the float bath has acquired its maximum width, lg (η_{A}/dPa*s), and at the end of hot forming, lg (η_{E}/dPa*s), is between at least 11.4 and at most 11.8.

In a further preferred embodiment, the viscosity in the apparatus for hot forming is adjusted such that the sum total of the common logarithms at the distance from a component for throughput regulation at which the glass after impinging on the float bath has acquired its maximum width, lg (η_{A}/dPa*s), and at the end of hot forming, lg (η_{E}/dPa*s), is between at least 11.4 and at most 11.6.

In other words, the method according to the present disclosure comprises a step in which the viscosity of the glass melt is adjusted such that the glass does not fall below a certain minimum viscosity. To the contrary, the viscosity is adjusted in a targeted way by—for example—targeted cooling of the glass before it is transferred to the apparatus for hot forming. However, the targeted establishment of a very high viscosity takes place not only at the start of the method; instead, it is advantageous to carry out targeted adjustment here of the overall operational viscosity, for which a suitable measure is the sum total of the common logarithms of the glass viscosity η of the glass comprised by the glass sheet at the distance from a component for throughput regulation at which the glass after impinging on the float bath has acquired its maximum width, and at the end of hot forming. Determined for this purpose are the common logarithm of the viscosity η_{A}, i.e., lg (η_{A}/dPa*s), at the distance from a component for throughput regulation at which the glass after impinging on the float bath has acquired its maximum width, and the common logarithm of the viscosity η_{E}, i.e., lg (η_{E}/dPa*s), at the end of hot forming, and the sum total of these values in accordance with the method lies within the above-stated limits—that is, between at least 11.4 and at most 11.8 or else preferably between 11.4 and at most 11.6. Because this sum total involves adding up the logarithmic values of the viscosities η_{A} and η_{E}, thus forming lg (η_{A}/dPa*s)+lg (η_{E}/dPa*s), this also corresponds to the common logarithm of the multiplication of these viscosity values, lg (η_{A}/dPa*s)+lg (η_{E}/dPa*s)=lg (η_{A}/dPa*s*η_{E}/dPa*s). Where the present disclosure mentions multiplication of the viscosity values η_{A} and η_{E}, or generally mentions viscosity values, as in the legends of the appended figures, for example, the intention thereby is also in each case to disclose the addition of their respective common logarithms.

It was hitherto known practice to adjust the viscosity to a defined value at the start of hot forming, and also to choose a fairly low value for this viscosity. However, it emerged that this still resulted in a significant degree of fine waviness. This is evident in particular when the surface properties are examined more closely, especially on examination of the presently disclosed fine wavinesses.

The assumption to date had been that it was advantageous, for the development of only minimal fine waviness, for the viscosity at the start of hot forming to be low, this being the viscosity during and shortly after the transfer of the glass melt to a hot-forming apparatus. The concept here was thereby to have a fluid of low viscosity which was able to flow and so self-compensate for any wavinesses in the hot forming operation.

Surprisingly, however, it emerged that this is not the case. Instead, for development of a particularly minimal fine waviness, it appears surprisingly to be much more advantageous if the viscosity is initially established at a targeted high level. The mechanism behind this is still not fully understood.

Additionally, however, careful monitoring of the viscosity—and, correspondingly, of the temperature control—is also highly advantageous in the method. It has also emerged that good, i.e., minimal, fine wavinesses cannot be achieved solely by a deliberately high initial viscosity. It is instead important to take a holistic view of the viscosity in the shaping procedure. One measure which has emerged for so doing, therefore, is the sum total of the common logarithms at the distance from a component for throughput regulation at which the glass after impinging on the float bath has acquired its maximum width, and at the end of hot forming. In accordance with the method, the viscosity is adjusted such that the sum total of the common logarithms of the viscosity at the distance from a component for throughput regulation at which the glass after impinging on the float bath has acquired its maximum width, and at the end of hot forming, is between at least 11.4 and at most 11.8.

By “the distance from a component for throughput regulation at which the glass after impinging on the float bath has acquired its maximum width”, and the “end” of hot forming, are meant, in this context, initially spatial limitations of the method. The start of the thickness-based shaping or of the shaping zone Hs within which a defined thickness of the glass is established is represented by the first top roller 12, 42, located at the start of the second float bath section 28, also referred to as bay 2 or float bath section 2, but at a different distance from the component for flow transit regulation by comparison with the distance at which the glass after impinging on the float bath has acquired its maximum width. In flow direction or drawing direction Y, the first top roller is at a distance of about 4.5 m from the component for throughput regulation, the tweel. More specifically, the start of the thickness-based hot-forming zone within which the glass undergoes its defined change in thickness is defined by the perpendicular 52 in negative z-direction, proceeding from the axis of symmetry 50 of the top roller 42 to the upper surface 36, thus to the upper principal surface 48 of the glass 8 for hot forming. However, the thickness-based hot forming, more particularly defined thickness-based hot forming, is only one part of the overall hot forming.

In the context of the present disclosure, the upper surface and the lower surface are also referred to respectively as upper principal surface and lower principal surface, since these principal surfaces, by comparison with lateral surfaces—and therefore surfaces which extend perpendicularly or transversely relative to these principal surfaces, especially which extend perpendicularly or transversely relative to them after singulation of the respective glass sheets—have in each case the largest areal extent.

The end of the hot-forming zone is defined by the last top roller 40, 44, which exerts a shaping influence on the glass ribbon for hot forming in flow direction or drawing direction, and is at a distance in flow direction or drawing direction Y of about 10.5 m to 11.1 m from the component for throughput regulation, the tweel 17. More specifically, the end of the hot-forming zone is defined by the perpendicular 53 in negative z-direction, proceeding from the axis of symmetry 51 of the last forming top roller 44 to the upper surface, in particular to the principal surface 48 of the glass 8 for hot forming. The abovementioned top rollers 12 and 42 and also 40 and 44 are also readily apparent, for example, from the appended FIGS. 3 and 4.

The lower surface or lower principal surface 49 of the glass for hot forming lies on the float bath 7 during the hot forming.

According to one embodiment, the viscosity is advantageously adjusted such that the common logarithm of the viscosity at the distance from a component for throughput regulation at which the glass after impinging on the float bath has acquired its maximum width, thus more particularly at a distance of 1.5 m in drawing direction Y from a component for throughput regulation, the tweel, and more particularly at the beginning of a second float bath section (or float bath section 2), is at least 5.0, more preferably at least 5.1, and preferably less than 5.25, and preferably the common logarithm at the end of hot forming, more particularly at a distance in drawing direction of about 10.5 m to 11.1 m after the component for throughput regulation, the tweel, and more particularly at the beginning of a fourth float bath section, is at least 6.2, preferably at least 6.3, more preferably at least 6.35, with a preferred upper limit being at most 6.5.

The inventors are of the view that, in contrast to the previous supposition, the fine waviness of the glass surface can be reduced particularly by specifically performing relatively cold hot forming, especially right at the beginning. The assumption to date had been that specifically a hot regime, in particular in the region of a glassmaking apparatus in which the glassy material is transferred from a melting apparatus into a region for hot forming, was advantageous for reducing surface structures such as fine waviness.

In fact it has emerged that what is referred to as a “hot regime”, being a regime in which the viscosity at the start of the hot-forming operation is low and is for example significantly less than 10^{5.0} dPa*s, enables a reduction in elevations of elongate extent which occur essentially in the direction of drawing of a float glass, and which are also referred to as drawing streaks. These drawing streaks form cylindrical-lenslike structures which appear to extend in the drawing direction and have refractivities which then manifest themselves substantially perpendicular to the drawing direction. It has turned out, however, that these drawing streaks—that is, fluctuations in thickness of the glass ribbon that occur transverse to the drawing direction and extend in the drawing direction—are not the cause of the fine wavinesses presently addressed. Instead, there are further phenomena which eclipse the formation of drawing streaks and which are substantially unaffected by measures which suppress merely the formation of drawing streaks.

As viewed from this standpoint, it has surprisingly emerged that in methods wherein the viscosity of the glassy material is established at a deliberately low level, i.e, for example, at below 10^{5.0} dPa*s, at the distance from a component for throughput regulation at which the glass after impinging on the float bath has acquired its maximum width, the resulting glass ribbon does indeed have fewer drawing streaks, but that other surface structures, particularly surface structures occurring in the drawing direction, may arise to an increased extent. These structures are structures of small area which do not lead to elevations or depressions parallel to the drawing direction (as in the case of the drawing streaks) but instead form irregular structures which are reminiscent of a leopard skin or “orange peel”.

Adjusting the viscosity at the start of hot forming is therefore not, as was hitherto thought, the only important factor for the overall further improvement in surface quality of glass ribbons or glass sheets (after singulation) produced by such a method. It is instead particularly advantageous to consider the overall viscosity in the hot forming. It has emerged here that the viscosity at the distance from a component for throughput regulation at which the glass after impinging on the float bath has acquired its maximum width, and also at the end of hot forming, is a good measure for assessing the method. As a simple measure for assessing the operation, use may be made here of the sum total of the common logarithms of the viscosity at the distance from a component for throughput regulation at which the glass after impinging on the float bath has acquired its maximum width, lg (η_{A}/dPa*s), and at the end of hot forming, lg (η_{E}/dPa*s). In accordance with the method, the sum total of the common logarithms of the viscosity at the distance from a component for throughput regulation at which the glass after impinging on the float bath has acquired its maximum width and at the end of hot forming is between at least 11.4 and at most 11.8.

Preferably, therefore, the common logarithm of the viscosity at the end of hot forming, more particularly at the beginning of a fourth float bath section at a distance of about 10.5 m to 11.1 m from a component for regulating the throughput of the flow of glass for hot forming, is at least 6.2, preferably at least 6.3, more preferably at least 6.35, with a preferred upper limit being at most 6.5. At this point in the hot forming, thus for example at the end of a fourth float bath section, the glass ribbon in a hot-forming procedure no longer exhibits the same contraction as before, and so the drawing there, via so-called border rollers or top rollers, is primarily in the drawing direction, with the extent of such drawing increasing in inverse proportion to the temperature of the glass ribbon.

While this is the case in principle, it has nevertheless emerged that now, specifically although the viscosity of the glass ribbon, at the distance from a component for throughput regulation at which the glass after impinging on the float bath has acquired its maximum width, in particular ahead of a component for throughput regulation and/or at the beginning of a first float bath section, is at least 5.0, more preferably at least 5.1, and less than 5.25, there must be strong drawing of the top rollers, and specifically also of a final top roller. At this location, a tension in the drawing direction is then preferably applied. In the middle of the hot forming, preferably, the top rollers, however, are situated on the outside with an angle of up to 15°. The high viscosity at the end of shaping prevents the narrowing (contraction) of the glass ribbon, including, for example, as a result of the tension of the cooling belt rollers.

In the case of a further preferred embodiment, the value of the difference between the common logarithms of the viscosity at the distance from a component for throughput regulation at which the glass after impinging on the float bath has acquired its maximum width, lg (η_{A}/dPa*s), and of the viscosity at the end of hot forming, lg (η_{E}/dPa*s), is between at least 1.2 and at most 1.5, more particularly between at least 1.2 and at most 1.45, and preferably is 1.42.

Up until now, a “cold” regime in glassmaking, at least at the start of the hot forming, was generally viewed as being unfavorable. Reasons for this are not only that it meant that the operation of production, particularly of hot forming, was then to be monitored more precisely overall, but also that it allowed only a comparatively low throughput.

Such a method can advantageously be carried out by means of floating. However, other glassmaking methods, especially a drawing method generally, may also be used for producing a glass sheet having an advantageously low fine waviness, more particularly a glass sheet according to embodiments.

In such a method, especially a continuous method, a glass ribbon is obtained which after leaving a lehr can then be processed further. It is possible here in particular to then singulate this glass ribbon to form a glass sheet.

The method according to the present disclosure may advantageously, according to one embodiment, be carried out in plants which are designed for a throughput of less than 400 t of glass per day, preferably less than 200 t of glass per day and more preferably less than 100 t of glass per day.

This is because the method is run “cool”, i.e., with comparatively high viscosity, not only beyond a distance from the component for throughput regulation at which the glass after impinging on the float bath has acquired its maximum width, but the viscosity at the end of hot forming is also adjusted in a very defined manner. This, as set out, is extremely advantageous for establishment of an advantageously low fine waviness. The temperature in the hot-forming operation is generally adjusted using heating units. However, in the case of particularly cool running, it should be borne in mind that the glassy material itself also transports heat. Beyond a particular throughput, it may therefore be necessary with further-increasing throughputs to withdraw heat from the glassy material itself, for example by means of special devices for cooling such as fans or the like. This means not just extra apparatus complexity and correspondingly higher costs, but can also have the effect that further properties are imposed on the glassy material or glass ribbon, such as thermal stresses, for example.

If, however, the throughput is limited, for example as specified above, removal of the heat transported by the glassy material itself is more easily possible, for example via the adjustment of the temperature of the tin bath in the respective float bath sections. Process regimes in assemblies with comparatively low throughputs are therefore particularly suitable for producing glass sheets having advantageously low fine waviness and/or low near-surface refractivities, especially when the presently disclosed method is employed therein.

It is advantageous when the adjusting of the viscosity of the glass melt is also undertaken prior to the transfer to the apparatus for hot forming upstream of a spout or at the site of a spout.

### Examples

The method described allows glass sheets composed of or comprising a borosilicate glass to be produced particularly advantageously. Illustrative compositions may be situated in the following compositional range, given in % by weight on an oxide basis:

| | |
|---|---|
| SiO₂ | 70 to 87, preferably 75 to 85 |
| B₂O₃ | 5 to 25, preferably 7 to 14 |
| Al₂O₃ | 0 to 5, preferably 1 to 4 |
| Na₂O | 0.5 to 9, preferably 0.5 to 6.5 |
| K₂O | 0 to 3, preferably 0.3 to 2.0 |
| CaO | 0 to 3 |
| MgO | 0 to 2. |

The glass of the glass sheet may more particularly comprises the following components in % by weight on an oxide basis:

| | |
|---|---|
| SiO₂ | 70 to 86 |
| Al₂O₃ | 0 to 5 |
| B₂O₃ | 9 to 25 |
| Na₂O | 0.5 to 5 |
| K₂O | 0 to 1 |

Additionally, the glass of the glass sheet may comprise the following components in % by weight:

| | |
|---|---|
| SiO₂ | 77 to 80 |
| Al₂O₃ | 2 to 5 |
| B₂O₃ | 9 to 11 |
| Na₂O | 2.6 to 5.2 |
| K₂O | 0.5 to 2.5 |
| MgO | 0 to 2 |
| CaO | 1.2 to 2.7 |

### BRIEF DESCRIPTION OF THE DRAWINGS

The invention is described in greater detail below, by means of the appended drawings and with reference to preferred and particularly preferred exemplary embodiments.

In the drawings,

FIG. 1 shows a schematic sectional view of an apparatus for producing a glass sheet and for implementing the presently disclosed method, in which the sectional plane runs vertically approximately through the middle of the apparatus,

FIG. 2 shows the schematic sectional view of FIG. 1 in greatly simplified form, in which the detail represented in FIG. 4 is marked with the sectional planes A and B,

FIG. 3 shows a schematic plan view of a part of the apparatus for producing a glass sheet that is shown in FIGS. 1 and 2, more particularly on a glass ribbon for hot forming on a float bath, in which illustratively, to simplify the representation, only some of the top rollers used overall are represented,

FIG. 4 shows a plan view, seen obliquely from above, of a part of the apparatus for producing a glass sheet, represented in FIGS. 1 and 2, in the form of a detail which extends between the sectional planes A and B,

FIG. 5 shows an illustrative representation of presently disclosed viscosity profiles, also indicating in particular the viscosity values η_{A} at a distance 56 from the component for throughput regulation at which the glass after impinging on the float bath has acquired its maximum width, and the viscosity values η_{E} at the end of the hot-forming section, and thus at the location of the perpendicular 53,

FIG. 6 shows the apparatus for producing a glass sheet, represented in FIG. 4, having measurement areas M1 to M8 indicated on the upper surface of the hot-formed glass ribbon and also having a measurement line ML for determining the fine waviness of the upper surface of the hot-shaped glass ribbon,

FIG. 7a shows a plan view of the upper surface of the glass ribbon after hot forming thereof, within the sectional planes C and D represented in FIG. 6, with the measurement areas M1 to M8, in each of which a measurement line ML is arranged,

FIG. 7b shows a plan view of the lower surface 49 of the glass ribbon 13 after hot forming thereof, within the sectional planes C and D represented in FIG. 6, with the measurement areas M1′ to M8′, in each of which a measurement line ML is arranged,

FIG. 8 shows a boxplot representation of the fine waviness values obtained for different viscosity values, as a function of the viscosities lg (η_{A}/dPa*s) and lg (η_{E}/dPa*s), where these fine wavinesses are each indicated for fixed values of the sum total of the viscosities lg (η_{A}/dPa*s)+lg (η_{E}/dPa*s) and where, in addition to these sum totals of the viscosities, the difference between them lg (η_{A}/dPa*s)−lg (η_{E}/dPa*s) is also indicated, with the respective boxplot representation including in each case the value of all the individual measurements resulting in this boxplot representation, and

FIG. 9 shows a boxplot representation of fine waviness values obtained for different viscosity values, as a function of the viscosities lg (η_{A}/dPa*s) and lg (η_{E}/dPa*s), where these fine wavinesses are each indicated for an interval of the sum total of the viscosities lg (η_{A}/dPa*s)+lg (η_{E}/dPa*s) and where, in addition to these sum totals of the viscosities, an interval of difference lg (η_{A}/dPa*s)−lg (η_{E}/dPa*s) is also indicated, with the boxplot representation including in each case the value of an individual measurement resulting in the boxplot representation shown in FIG. 9.

### DETAILED DESCRIPTION OF THE INVENTION

In the description of preferred and particularly preferred embodiments that follows, reference signs that are the same in the various figures denote identical constituents, or constituents that have the same effect, of the apparatus respectively disclosed here.

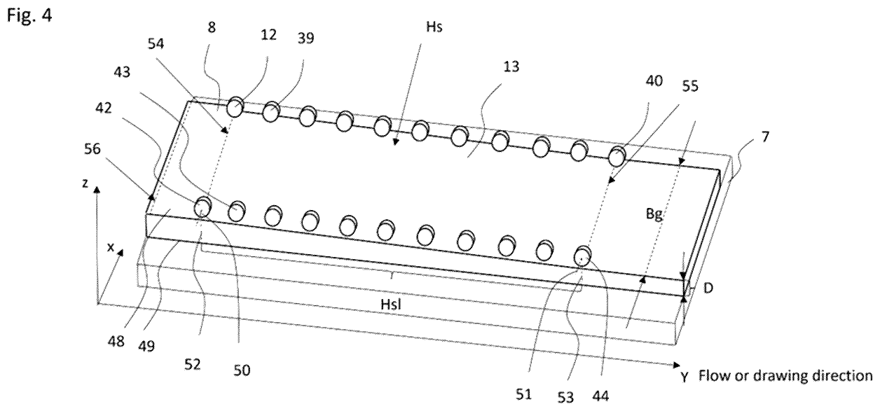

The data for the thickness D of the glass sheet 33, 33′, 33″ correspond to the distance between the two principal surfaces, namely the top side 34 and the bottom side 35, of the glass sheet 33, 33′, 33″ after its hot forming, and should each be measured perpendicularly to these principal surfaces, as represented illustratively in FIG. 4.

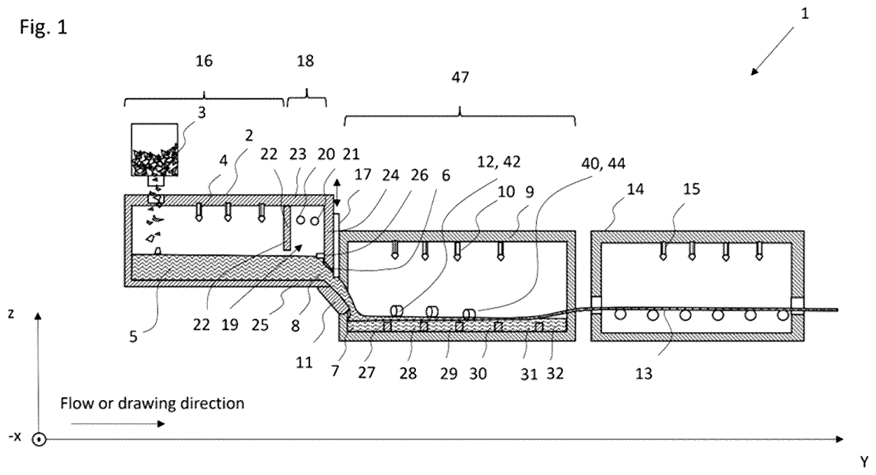

The float plant represented in FIGS. 1, 2 and 3 for implementing the presently disclosed method has a melting furnace 2, also referred to as a melting vessel, which is supplied conventionally with a batch for melting, more particularly a glass batch 3, and is heated by means of burners 4 until a glass melt 5 having the desired composition is formed. Further facilities for homogenizing the glass melt are known to the skilled person and are consequently not described in more detail.

Through a channel 6, the molten glass of the glass melt 5, generally under the effect of gravity, reaches a float bath 7 which contains liquid tin and on which the glass 8 for hot forming is able to spread laterally with a reduction in its height, as part of its hot forming, under the effect of gravity.

For adjusting the temperature of the glass for hot forming, the tin bath 7 may be arranged in a float bath furnace 9 which possesses electrical overhead heaters 10 by means of which the temperature of the glass for hot forming can be adjusted. Additionally, the temperature of the tin bath 7 may be adjusted in a defined manner in the drawing direction and in this way the temperature of the glass for hot forming and hence its viscosity may be influenced in a defined manner.

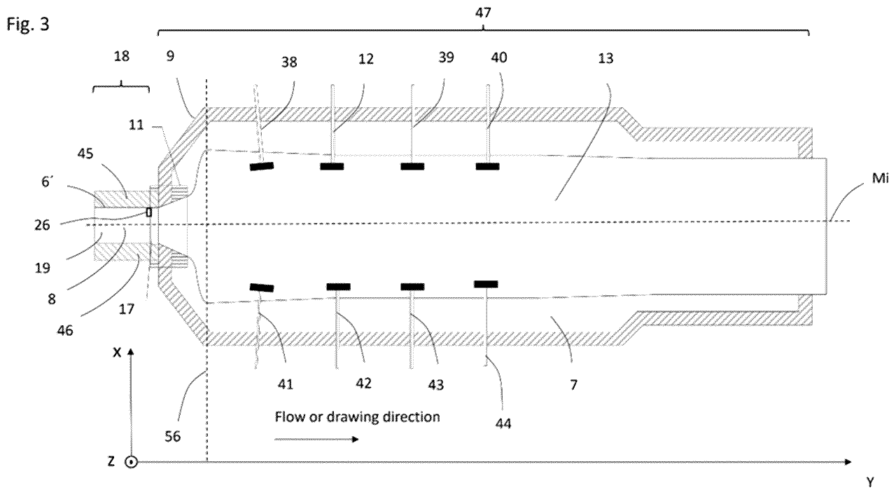

On exiting the melting vessel 2, the molten glass 8 for hot forming is conveyed over a downward-slanting introduction lip 11, also referred to as a spout, on which the glass already begins to widen, onto the tin bath 7. At a distance of 1.5 m from the component for throughput regulation, and hence at a distance of 1.5 m in the Y-direction in the midpoint Mi of the glass ribbon 13 with respect to the X-direction, the glass ribbon 13 has its greatest width, meaning its greatest extent in the X-direction. In the case of the embodiments disclosed, this distance is about 1.5 m and is indicated with the reference sign 56 in FIG. 4, for example. With roll-shaped top rollers 12 as a tensioning facility, the glass ribbon 13 which forms on the tin bath 7, in its spreading motion from the side, is subjected to defined influencing in its further motion. Illustratively, only three top rollers are represented in each case in FIG. 1, although, as and when required, it is also possible for more than two of these top rollers to be present and used, as is also apparent, for example, from FIGS. 3 and 4.

Top roller refers to an essentially roll-shaped body that is well known to the person skilled in this field of art, which is in contact by its outer annular shoulder with the principal surface remote from the tin bath, or upper surface 48, of the glass 8 to be hot-formed and which exerts a force on the glass 8 to be hot-formed in each case by a rotating movement in each case about its longitudinal axis or axis of symmetry 50, 51. This axis of symmetry 50, 51 is shown merely illustratively for the top rollers 42 and 44. In the context of the present disclosure, the term “top roller” may also be regarded as an essentially roll-shaped transport apparatus for the glass to be hot-formed. In this context, the first top roller 12, 42 constitutes an essentially roll-shaped transport apparatus for the glass to be hot-formed at the start of the section Hs, especially a defined, thickness-based hot-forming zone, and the last top roller 40, 44 constitutes an essentially roll-shaped transport apparatus for the glass to be hot-formed at the end of the section Hs of the hot-forming zone. Over the course of this thickness-based hot-forming zone Hs, the thickness of the glass ribbon 13 is adjusted in a defined manner, but this hot-forming zone Hs does not include all hot-forming measures, since, even after the distance 56 from the component for throughput regulation at which the glass after impinging on the float bath has acquired its maximum width up to the start of the section Hs, there is already forming of the glass 8 to be hot-formed in the glass ribbon 13.

The portion of the glass 8 to be hot-formed which is in contact with the outer annular shoulder of the respective top roller causes it to move in a defined manner. The top roller is in each case driven in a defined manner, being controllable by motor with an essentially rod-shaped axle.

The location or position of the top roller, especially in flow direction Y of the glass 8, is understood in the context of the present disclosure in each case to be the perpendicular 52, 53 in negative z-direction proceeding from the respective axis of symmetry 50, 51 of the corresponding top roller 42, 44 from the surface, especially from the principal surface 48, of the glass 8 to be hot-formed.

The location or position of the respective first top roller 12, 42 defines the entry of the glass 8 into the section Hs for hot forming thereof with regard to its thickness.

The location or position of the respective last top roller 40, 44 defines the exit of the glass 8 from the section Hs for thickness-based hot forming thereof and hence for overall hot forming thereof.

By way of simplification, in the context of the present disclosure, the mention of the first top roller in each case refers to the pair of top rollers, for example the top rollers 42, 12, that are at the same site in flow direction, and the mention of the last top roller in each case refers to the pair of top rollers, for example the top rollers 44, 40, that are each at the same site in flow or y-direction.

The site of entry of the glass 8 into the section Hs for thickness-based hot forming is consequently apparent by virtue of the dashed line 54, whereas the site of exit of the glass 8 from the section Hs for hot forming is indicated by the dashed line 55.

A further dashed line indicates the site or distance 56 from the component for throughput regulation at which the glass 8 to be hot-formed has reached its maximum width after impinging on the float bath 7.

The length Hsl of the section Hs for thickness-based hot forming in the context of the present disclosure is understood to mean the distance in flow or y-direction between the perpendicular 52 of the first top roller 42 and the perpendicular 53 of the last top roller 44.

After hot forming thereof, the glass ribbon 13 can optionally be transferred to a lehr 14, which may likewise have electrical overhead and floor heaters 15, in order to subject the glass ribbon 13 to a defined lowering of temperature, although only overhead heaters are shown by way of illustration in FIG. 1.

After leaving the lehr 14, the glass ribbon 13 is then available for further processing, especially singulation into glass sheets 33, 33′, 33″.

In order, in the description of preferred embodiments that follows, to be able to more clearly illustrate spatial arrangements of different assemblies or of properties, for example of glasses to be hot-formed or glass sheets 33, 33′, 33″ singulated after hot forming, reference is firstly made to the Cartesian coordinate system shown in FIGS. 1, 2, 3 and 4, which defines an orthogonal X-, Y- and Z-direction, to which all statements continue to relate hereinafter in the various figures.

The X- and Y-directions form a plane that extends horizontally and hence also runs essentially parallel to the surface of the tin bath 7. Running perpendicular to this plane, the Z-direction extends upward and thereby also defines the normal direction in relation to the glass ribbon 13.

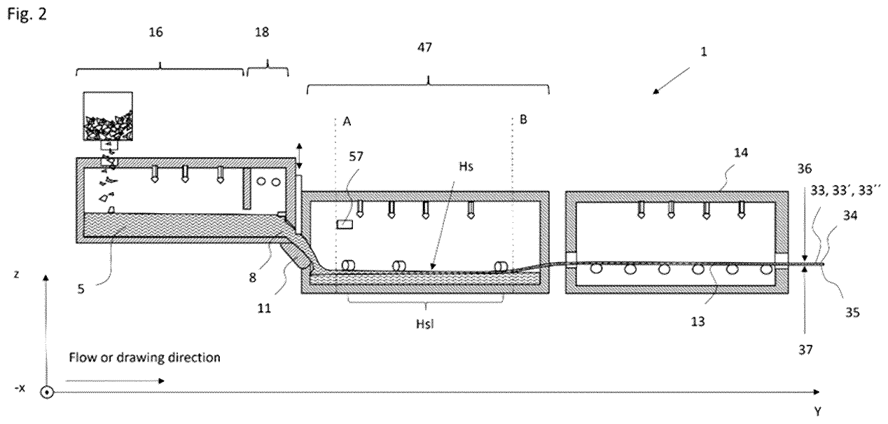

Reference is made hereinafter to FIG. 1, which, as an apparatus for production of a glass ribbon 13 from which the presently disclosed glass sheets 33, 33′, 33″ can be singulated, comprises the float apparatus that has been given the reference sign 1 as a whole, which has all the facilities or apparatuses described with reference to FIGS. 2, 3 and 4.

Facilities for melting 16 that are included here are the melting vessel or melting furnace 2, a feed device for the glass batch 3, and the burners 4. In addition, the melting vessel 2 has a channel 6 for transfer of the molten glass 8 to be hot-formed to the tin bath 7.

By way of illustration, the control slider 17, i.e. the component for throughput regulation of the glass flow, which is also referred to as a tweel, is disposed behind the channel 6. By movement of the control slider or tweel 17, which forms the component 17 for throughput regulation, in the direction of the double-headed arrow shown alongside reference sign 17, it is possible to constrict or enlarge the cross section of the channel 6, which regulates, and especially adjusts in a defined manner, the amount of molten glass 8 to be hot-formed that exits from the melting vessel 2 per unit time. In addition, a feeder may be disposed between the melting vessel 2 and the float bath furnace 9, especially upstream of the tweel 17, which in this case forms the channel 6, especially also over a longer distance than that shown in FIG. 1. A more detailed description of throughput regulation can be found in this applicant's DE 10 2013 203 624 A1, which is also incorporated into the subject-matter of the present application by reference.

Viewed in flow direction of the molten glass 8 to be hot-formed, a facility 18 for defined adjustment of the viscosity of the molten glass 8 to be hot-formed is disposed upstream of the component for throughput regulation 17 and upstream of the spout 11.

This facility 18 for defined adjustment of viscosity comprises a chamber 19 that is divided from the melting vessel 2 or else may form part thereof, and accommodates the molten glass 8 to be formed to a glass substrate for defined adjustment of the viscosity thereof.

In addition, the facility 18 for defined adjustment of viscosity comprises regions 20, 21 through which fluid flows, especially regions through which water flows, which absorb heat from the glass 8 to be hot-formed and may take the form of a metallic pipe system. This metallic pipe system may also be colored for better absorption of heat or provided with a heat-resistant paint on the surface thereof.

Alternatively or additionally, the walls 22, 23, 24 and 25 of the chamber 19 may also absorb heat from the glass 8 to be hot-formed in that the temperature thereof is adjusted in a defined manner, for example by further cooling facilities.

The chamber 19, with its walls 22, 23, 24 and 25, may also be formed spatially separately from the melting vessel 2 and have high-temperature-resistant metallic walls, in order to provide improved dissipation of heat.

As described above, the facility 18 for defined adjustment of viscosity comprises at least one cooling facility by means of which the temperature and hence also the viscosity of the glass 8 to be hot-formed is adjustable in a defined manner.

Contactless and, alternatively or additionally, direct temperature measurements in contact with the glass to be measured are known to the person skilled in the art. Corresponding sensors are described, for example, by the sensor device or unit 26 in the context of this disclosure.

The sensor device or unit 26 may be in direct contact with the glass and hence undertake a direct temperature measurement, or else may comprise a radiative measurement device that detects the temperature by detection of the spectrum emitted by the glass 8 to be hot-formed with reference to the spectrum itself and/or the intensity of the radiation emitted.

The apparatus 1 comprises a facility or apparatus 47 for hot forming, which will be described in more detail hereinafter, which is present beyond the facility 18 for defined adjustment of viscosity in flow direction or drawing direction and receives the glass 8 to be hot-formed via the spout 11.

The spout 11 directs the glass 8 to be hot-formed onto a tin bath 7 accommodated in the float bath furnace 9.

A further cooling facility 57 is disposed above the glass 8 to be hot-formed at a distance from the component for throughput regulation 17 of about 2 m based on the middle thereof in Y-direction. This cooling facility 57 projects above the melt and may have a width in Y-direction of 300 mm, a height in Z-direction of 80 mm and a length in X-direction of 2.5 meters, and may be in two-part form. In this case, a portion of the cooling facility 57 projects over the glass to be hot-formed from respective opposite sides in X direction, and hence provides an essentially complete cover of the glass 8 to be hot-formed in X-direction and regionally in Y-direction.

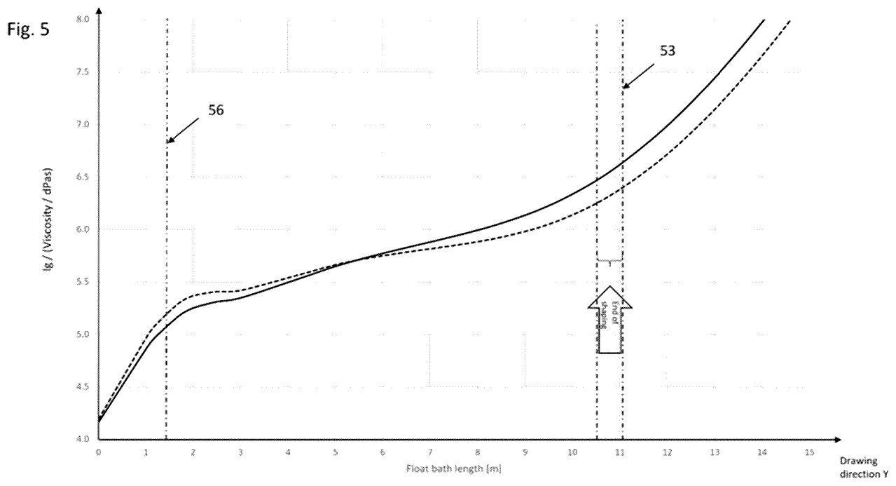

The cooling facility 57 shadows the glass 8 to be hot-formed not just with respect to the overhead heaters 10, but also brings about a cooling air stream that comes from above the glass 8, with which it is possible to cool the glass 8 present beneath the cooling facility 57 down by about 20 to 25 K. In this way, given the already initially high viscosity of the glass 8, it is possible to create a flatter progression of the viscosity curve overall in the continued progression in drawing direction, as also shown by way of example in FIG. 5.

Above the glass ribbon 13 that forms on the tin bath 7, as also readily apparent from FIG. 3, further top rollers 38 to 44 are disposed alongside the top roller 12 for mechanical movement of the glass ribbon 13.

In this context, the number of top rollers shown in FIG. 3 is merely illustrative since, in preferred embodiments of the invention, preferably 10 to 12 pairs of top rollers are used.

The top rollers 41 and 38 serve merely for adjustment of the width of the glass ribbon Bg 13 that results from the hot forming, and are optional since the width Bg is also adjustable in other ways, for example by regulating the volume of glass 8 which is provided for hot forming.

FIG. 3 also shows an alternative or additional configuration of the facility 18 for defined adjustment of viscosity. The molten glass 8 is present in a channel 6 of the melt vessel 2, not shown in FIG. 3, to the float bath furnace 9. The walls 45, 46 of the channel 6 have been formed from a metal of high thermal stability, for example platinum, which may also be disposed as a metallic layer on a mineral refractory material. The defined adjustment of the temperature of these walls allows heat to be withdrawn from the glass 8, and also the temperature and viscosity thereof to be adjusted in a defined manner. In this embodiment too, the above-described sensor unit 26 may preferably be disposed close to the tweel 17.

A drawing facility has been described above for the apparatus 47 for hot forming, which comprises a float facility, especially a float bath furnace 9 with a tin bath 7.

The method disclosed here is described by way of illustration hereinafter with reference to a float method.

FIG. 4 shows a detail extending between the sectional planes A and B of the apparatus 1 for production of a glass ribbon 13 for a glass sheet 33, 33′, 33″ to be singulated therefrom, in which, for better clarity, only the glass 8 to be hot-formed, and also the float bath 7 in the form of a tin bath, are shown.

The glass 8 moves from the left-hand side of FIG. 4 at an entry speed onto the first top roller 42, 12, at which the thickness-based hot forming disclosed here to give a glass ribbon 13 for a glass sheet 33, 33′, 33″ to be singulated therefrom commences. This speed corresponds to the speed of the glass 8 at the first top roller 42, 12. The glass 8, after the last top roller 40, 44, and hence after it has been hot-formed as described here, moves onward in flow direction to a glass ribbon 13 for a glass sheet 33, 33′, 33″ with an exit thickness D to be singulated therefrom.

Where reference is made for short merely to hot forming in the context of the present disclosure, this refers, for linguistic simplicity, to the hot forming described in more detail hereinafter to give a glass ribbon 13 for a glass sheet 33, 33′, 33″ to be singulated therefrom, especially after cooling of the glass ribbon 13, both along the section Hs of the thickness-based hot-forming zone and further hot-forming steps that may have already taken place before attainment of the first top roller, as, for example, in the pouring of the glass 8 onto the float bath 7, where the glass can spread out two-dimensionally and assume its equilibrium thickness Dg of about 7 mm+/−1 mm.

After the hot forming, the glass 8 has an exit thickness of D that it assumed after the last top roller 40, 44.

The glass 8, throughout its thickness-based hot forming to give a glass ribbon 13 for a glass sheet 33, 33′, 33″ to be singulated therefrom, between the first top roller 42, 12 and the last top roller 40, 44, and hence in the section Hs, has a width Bg, i.e., an extent in x-direction of Bg, which is altered preferably by less than 3% in this thickness-based hot forming in x-direction. This can be ensured by adjusting the speed and angle of rotation along the axis of symmetry (axis of rotation) of the respective top rollers. In this case, it is especially also possible to alter the angle of the respective axis of symmetry of the corresponding top roller such that this results in greater or lesser contributions of the movement of the glass 8 to be hot-formed or of parts of the glass ribbon 13 in x-direction in the course of transport of glass 8 to be hot-formed, especially along the thickness-based hot-forming zone Hs.

At a distance 56 from a component for throughput regulation 17 at which the glass after impinging on the float bath has acquired its maximum width, the viscosity η_{A}, especially by adjustment of the temperature of the glass ribbon 13 at this site, is adjusted such that this has a value of lg (η_{A}/dPa*s) of at least 5.0, more preferably at least 5.1, and preferably less than 5.25.

At the end of the hot forming zone Hs, the viscosity η_{E}, especially by adjustment of the temperature of the glass ribbon 13 at this site, is adjusted such that this has a value of lg (η_{E}/dPa*s) of at least 6.2, preferably at least 6.3, more preferably at least 6.35, where a preferred upper limit assumes the value of 6.5 at most.

According to the invention, the viscosity in the apparatus for hot forming is adjusted such that the sum of the common logarithms of the viscosity lg (η_{A}/dPa*s) and lg (η_{E}/dPa*s) at the distance 56 from a component for throughput regulation 17 at which the glass after impinging on the float bath has acquired its maximum width, and at the end of hot forming, is between at least 11.4 and at most 11.8 η dPa*s.

An illustrative representation of corresponding viscosity profiles can be seen in FIG. 5, in which, in particular, the viscosity values η_{A} at the distance 56 from a component for throughput regulation 17 at which the glass after impinging on the float bath has acquired its maximum width, and the viscosity values η_{E} at the end of the hot forming zone, and hence of the perpendicular 53, can also be inferred.

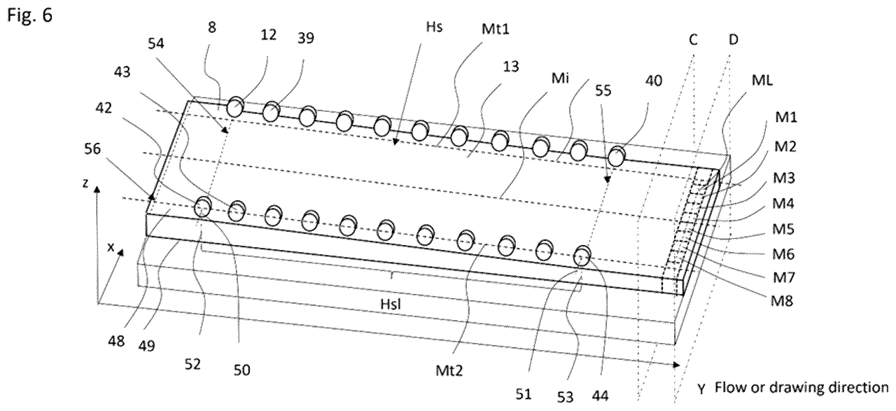

Reference is made below to FIG. 6, which shows the apparatus represented in FIG. 4 for producing a glass sheet, having measurement areas M1 to M8 indicated on the upper surface 48 of the hot-formed glass ribbon 13, and having an illustrative measurement line ML for determining the fine waviness of the upper surface 48 of the hot-formed glass ribbon 13. Although the measurement line ML represented in FIG. 6 is represented, for the sake of simplicity, initially as a continuous line, it consists of respective measurement lines ML of the measurement areas M1 to M8, as is elucidated further in more detail with reference to FIGS. 7a and 7b.

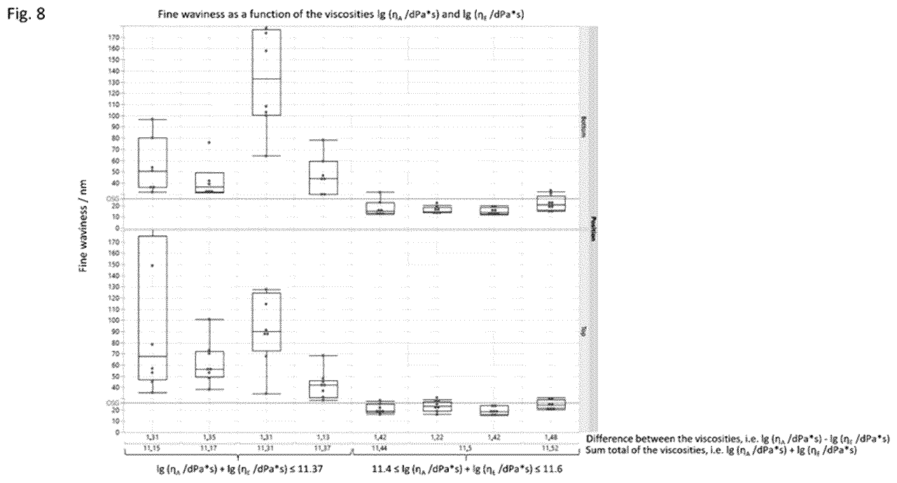

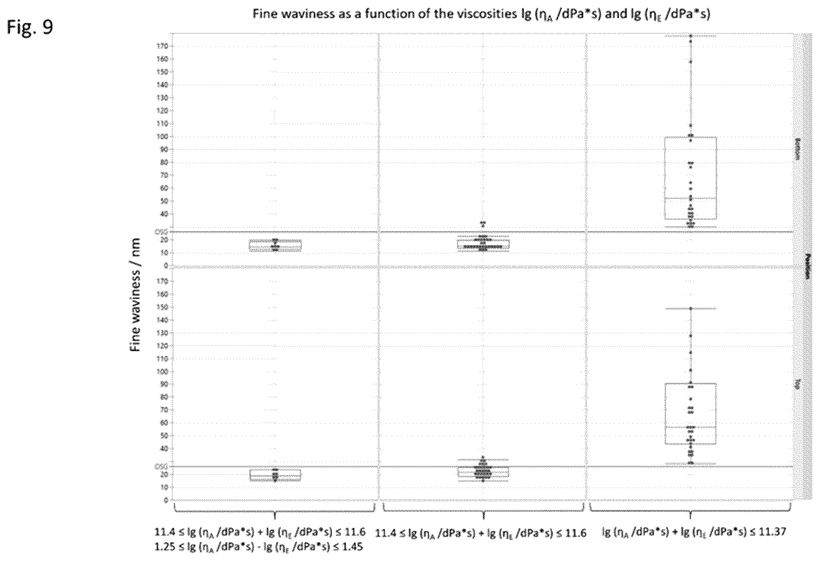

Glass sheets 33, 33′, 33″ singulated from the glass ribbon 13 may comprise one or more of these measurement areas or else may comprise fractions of these measurement areas. From the data elucidated in more detail below and represented in FIGS. 8 and 9, it is also evident that the fine waviness values of the invention are reliably achieved as soon as a singulated glass sheet 33, 33′, 33″ with its dimensions in the X-direction reaches at least the length of a measurement zone ML, since even mutually bordering measurement zones ML, which do not each have to have been covered over their full length, lead essentially to the fine wavinesses of the invention as soon as the length of one measurement zone ML is reached overall. The same applies to the measurement areas M1′, M2′, M3′, M4′, M5′, M6′, M7′ and M8′ that are located at the bottom side 49. Merely by way of illustration, the dimensions of glass sheets 33′ and 33″ subsequently singulated from the glass ribbon are represented in FIGS. 7a and 7b in this respect.

Also represented in dashed form in FIG. 6 are sectional planes C and D which extend in the Z- and X-directions and which the glass ribbon 13 after hot forming thereof passes through in the drawing direction Y. The measurement areas M1 to M8 indicated on the upper surface of the hot-formed glass ribbon are represented illustratively for a defined timepoint t after the hot forming of the glass ribbon 13, and move with the glass ribbon 13 in drawing direction Y, and form a part of the upper surface of the hot-formed glass ribbon, more particularly for the subsequent singulation thereof into glass sheets 33, 33′, 33″. Since the glass ribbon after hot forming thereof undergoes no further change in size, the measurements were performed subsequently on singulated glass sheets 33, for which a measured glass sheet 33 comprised a respective one of the measurement areas M1, M2, M3, M4, M5, M6, M7 or M8 and one of the measurement areas M1′, M2′, M3′, M4′, M5′, M6′, M7′ or M8′.

The measurement areas M1, M2, M3, M4, M5, M6, M7 and M8 are shown in FIG. 6 arranged on the upper surface 48 and they each have a square shape with an extent in both the X-direction and the Y-direction of 260 mm. This dimension of 260 mm is also shared by the respective measurement zone ML.

For the sake of clarity, the dimensions shown in the figures are not represented to scale; instead, the thickness D, in particular, is initially represented in a greatly enlarged form for the sake of greater ease of perceptibility.

Fine waviness measurements were performed at the upper surface 48 and also at the lower surface 49 along a measurement line ML represented in each of FIGS. 7a and 7b.

Because the measurement areas M1, M2, M3, M4, M5, M6, M7 and M8 and also the measurement areas M1′, M2′, M3′, M4′, M5′, M6′, M7′ and M8′ extend transverse to the extent of the glass ribbon 13 in the X-direction, the recording of the entire glass ribbon 13 used for the singulation of the glass sheets after the hot forming is made possible in the X-direction in this way.

Regions lying under the top rollers 38 to 44 were not recorded by the fine waviness measurements and are each delimited in the X-direction by the lines Mt1 and Mt2, illustratively, with respect to the region of the glass ribbon 13 lying between these lines Mt1 and Mt2, so that surface-altering effects of the top rollers were not recorded by the fine waviness measurements. Lateral borders which may rise above the upper principal surface 48 in the Z-direction at the edge of the glass ribbon 13 are each situated behind the top rollers 38 to 44, in relation to the midpoint Mi of the glass ribbon, and are therefore likewise situated outside a respective measurement region ML. They too, therefore, were not recorded by a respective fine waviness measurement.

FIG. 7a shows a plan view of the upper surface 48 of the glass ribbon 13 after hot forming thereof within the sectional planes C and D represented in FIG. 6, with the measurement areas M1 to M8, each containing a measurement line ML, and FIG. 7b shows a plan view of the lower surface 49 of the glass ribbon 13 after hot forming thereof within the sectional planes C and D represented in FIG. 6, with the measurement areas M1′ to M8′, each containing a measurement line ML.

The measurement areas M1′ to M8′ indicated in FIG. 7b at the lower surface 49 of the hot-formed glass ribbon 13 are also represented illustratively for a defined timepoint t after the hot forming of the glass ribbon 13, move with the glass ribbon 13 in the drawing direction Y, and form a part of the lower surface 49 of the hot-formed glass ribbon 13, more particularly for its subsequent singulation into glass sheets 33, 33′, 33″.

By way of illustration, glass sheets 33 were singulated in particular such that there was a respective measurement area of the measurement areas M1 to M8 at their upper surface and a respective measurement area of the measurement areas M1′ to M8′, with numerical correspondence of the respective measurement areas, at their lower surface.

The fine waviness was determined presently by measuring the surface of a glass sheet using a ZEISS Surfcom 1400-350 surface and contour measuring instrument (with the release P000083259) along a direction perpendicular to the drawing direction Y and thus running in the X-direction on the surface of the top side and the surface of the bottom side of the respective glass sheet within a measurement area M1 to M8 and also M1′ to M8′. The aforementioned X-direction can be seen, for example, in the Cartesian coordinate system represented in FIGS. 1 to 4. For this instrument, a lower cut-off wavelength λc was chosen at 0.25 mm and an upper cut-off wavelength λf of 8 mm. Filtering took place using a Gaussian filter. The fine waviness values output by this contour measuring instrument are also referred to in the manner customary in the art as Wfpd values and are also output thus referenced by said measuring instrument.

FIGS. 8 and 9 show boxplot representations, known per se to the skilled person, which are ascertained in each case for a multiplicity of measurement values, as for example eight measurement values of eight measurement lines ML.

Merely for the sake of completeness it may be noted that a boxplot representation comprises a rectangular box with a line running transversely in this box and with “whiskers” extending upward and downward out from this box. This line running transversely in the box corresponds in each case to the median of the measurement values, being the value for which a first half of the measurement values are located above or on this line and the second half of the measurement values are located below or on this line. The upper border of the box represents the three-quarters quartile of the measurement values, for which three quarters of the measurement values are located below or on the upper border of the box and one quarter of the measurement values are located above or on the upper border of the box. The lower border of the box represents the one-quarter quartile of the measurement values, for which one quarter of the measurement values are located below or on the lower border of the box and three quarters of the measurement values are located above or on the lower border of the box. Via their length, these whiskers extending upward or downward out from the box each indicate expected values which correspond to 1.5 times the distance from the bottom end of the box to the top, unless the values actually measured do not reach that far, in which case they extend from the bottom end of the box to the respective measured minimum value or extend from the top end of the box to the respective measured maximum value.

FIG. 8 shows a box plot representation of the fine waviness obtained for various viscosity values as a function of the viscosities lg (η_{A}/dPa*s) and lg (η_{E}/dPa*s).

As in FIG. 9, the indication “Position Top” denotes the measurement values of the upper surface 48 of the glass ribbon 13, and especially the measurement values of the surface of the top side 36 of glass sheets 33, 33′ and 33″ singulated from this glass ribbon. Just as in FIG. 9, the indication “Position Bottom” denotes the measurement values of the lower surface 49 of the glass ribbon 13, and especially the measurement values of the surface of the bottom side 37 of glass sheets 33, 33′ and 33″ singulated from this glass ribbon.

FIG. 8 indicates the values of the fine wavinesses as the ordinate in a lower caption line in each case for fixed values of the sum total of the viscosities lg (η_{A}/dPa*s)+lg (η_{E}/dPa*s), and indicates the values for the difference between the viscosities lg (η_{A}/dPa*s)−lg (η_{E}/dPa*s) in an upper caption line of the ordinate.

The sum total of the above-indicated viscosities was as follows:

$$l g ( {η}_{A} / dPa * s ) + l g ( {η}_{E} / dPa * s ) = 11 \text{.15}$$

$$lg ( {η}_{A} / dPa * s ) + l g ( {η}_{E} / dPa * s ) = 11 \text{.17}$$

$$lg ( {η}_{A} / dPa * s ) + l g ( {η}_{E} / dPa * s ) = 11.31$$

$$lg ( {η}_{A} / dPa * s ) + l g ( {η}_{E} / dPa * s ) = 11.37$$

$$lg ( {η}_{A} / dPa * s ) + l g ( {η}_{E} / dPa * s ) = 11.44$$

$$lg ( {η}_{A} / dPa * s ) + l g ( {η}_{E} / dPa * s ) = 11.5$$

$$lg ( {η}_{A} / dPa * s ) + l g ( {η}_{E} / dPa * s ) = 11.52$$

It can be seen that below a value for the sum total of the viscosities of about lg (η_{A}/dPa*s)+lg (η_{E}/dPa*s)=11.4, the fine waviness values are above 26 nm, with this value of 26 nm being reproduced in FIGS. 8 and 9 as a line bearing the designation OSG.

Located above the value for the sum total of the viscosities of lg (η_{A}/dPa*s)+lg (η_{E}/dPa*s)=11.4 is a region of decreasing fine wavinesses, more particularly of fine wavinesses having values below 26 nm, more particularly decreasing down to 10 nm.

For example, the fine waviness values obtained on the bottom side for a sum total of the viscosities of about lg (η_{A}/dPa*s)+lg (η_{E}/dPa*s)=11.6 and a difference between the viscosities lg (η_{A}/dPa*s)−lg (η_{E}/dPa*s)=1.42 reliably show values of between 10 nm and 15 nm.

The fine waviness values rise slightly again beyond a value for the sum total of the viscosities of about lg (η_{A}/dPa*s)+lg (η_{E}/dPa*s)=11.42.

A preferred range comes about in particular if the viscosity in the apparatus for hot forming is adjusted such that the sum total of the common logarithms of the viscosity at the distance from a component for throughput regulation at which the glass after impinging on the float bath has acquired its maximum width, lg (η_{A}/dPa*s), and of the viscosity at the end of hot forming, lg (η_{E}/dPa*s), is between at least 11.4 and at most 11.6, since in that case the values of the medians, of a multiplicity of glass sheets, for example, in particular of at least eight glass sheets 33, 33′, 33″, more particularly of glass sheets 33, 33′, 33″ having the features of the claims from 1 to 4, each formed from the fine wavinesses, measured along the line ML, of a respective glass sheet 33, 33′, 33″ of the set, are each reliably situated at a fine waviness of 10 nm to 26 nm. It is assumed in this context that the respective glass sheet 33, 33, 33″ of the set in each case comprised at least one size extent in X-direction with the length of one complete measurement zone M1, even if this extent was provided not in each case independently by a single measurement zone ML but instead from fractions, for example, of two measurement zones ML.

Up to a value of a value of about lg (η_{A}/dPa*s)+lg (η_{E}/dPa*s)=11.8, it was likewise still possible to obtain correspondingly measured fine waviness values of less than 26 nm.

Reference is made below to FIG. 9, which shows a boxplot representation of fine waviness values obtained for various viscosity values, as a function of the viscosities lg (η_{A}/dPa*s) and lg (η_{E}/dPa*s).

The fine waviness values are indicated in each case for an interval of the sum total of the viscosities lg (η_{A}/dPa*s)+lg (η_{E}/dPa*s).

In addition to these sum totals of the viscosities, for the first interval, being the interval on the left-hand side of FIG. 9, an interval of difference lg (η_{A}/dPa*s)−lg (η_{E}/dPa*s) is also indicated.

The inventors have surprisingly determined a further advantageous criterion which may be explained illustratively with reference to the values, represented in FIG. 9, for the sum totals of the viscosities of lg (η_{A}/dPa*s)+lg (η_{E}/dPa*s)=11.6 and also for the differences between the viscosities, lg (η_{E}/dPa*s)−lg (η_{A}/dPa*s).

In the interval of the middle representation in FIG. 9, for which the sum total of the viscosity values is subject to 11.4≤lg (η_{A}/dPa*s)+lg (η_{E}/dPa*s)≤11.6, values for the fine waviness of less than 26 nm were reliably achieved even for the median of the presently described set, and in particular for the upper surface 48, median fine waviness values of the set were measured which are less than 20 nm and greater than 10 nm.

Where, however, an additional criterion was introduced, namely that the difference between the common logarithms of the viscosity at the distance from a component for throughput regulation at which the glass after impinging on the float bath has acquired its maximum width, lg (η_{A}/dPa*s), and of the viscosity at the end of hot forming, lg (η_{E}/dPa*s), is between at least 1.25 and at most 1.45, and preferably is 1.42, in that case virtually all the values measured for the fine waviness, especially on an entire set described here, were below 26 nm, and the spread of these values was significantly reduced.

The fine waviness values obtained with this additional criterion are represented in the left-hand column of FIG. 9.

In the interval of the left-hand representation in FIG. 9, for which the sum total of the viscosity values is subject to 11.4≤lg (η_{A}/dPa*s)+lg (η_{E}/dPa*s)≤11.6 and the difference is subject to 1.25≤lg (η_{A}/dPa*s)−lg (η_{E}/dPa*s)≤1.45, values for the fine waviness of less than 20 nm were reliably achieved even for the median of the presently described set, not only for the surface 48 but also for the surface 49, and the values of the median were generally greater than 10 nm.

Where median values are presently indicated, they were obtained in each case, for the surface 48, from values of the measurement areas M1 to M8 and, for the bottom side, from values of the measurement areas M1′ to M8′. However, where these values did not include those of the outer measurement areas M1 and M8 and also M1′ and M8′, fine waviness values smaller than are represented in FIGS. 8 and 9 were generally obtained.

The value for the difference between the viscosities lg (η_{E}/dPa*s)−lg (η_{A}/dPa*s)=1.25 was attained for example through the preferred viscosities lg (η_{A}/dPa*s)=5.1 and lg (η_{E}/dPa*s)=6.35. The value for the difference between the viscosities lg (η_{E}/dPa*s)−lg (η_{A}/dPa*s)=1.45 was attained for example through the viscosities lg (η_{A}/dPa*s)=5.0 and lg (η_{E}/dPa*s)=6.45, with the above viscosity value at the end of hot forming of 6.45 being only slightly below the indicated preferred maximum limit of 6.5, and being obtained as a direct result of the methodology presently described.

In the case, however, of singulation of glass sheets 30 which encompassed the measurement areas M3 to M6 or M3′ to M6′ situated closer to the midpoint line Mi in X-direction, then all of the fine waviness values measured in these measurement areas along the respective measurement line ML were reliably below 26 nm. This means that all of the measured fine wavinesses within a positive and also negative distance in X-direction from the midpoint line Mi of 910 mm were then below 26 nm, as is represented for example in the left-hand column of FIG. 9.

In particular, the statement in this paragraph is also valid for intervals with 11.4≤lg (η_{A}/dPa*s)+lg (η_{E}/dPa*s)≤11.6 and 1.25≤lg (η_{A}/dPa*s)−lg (η_{E}/dPa*s)≤1.45, for which the value for the difference between the viscosities lg (η_{E}/dPa*s)−lg (η_{A}/dPa*s)=1.5 was achieved for example through the viscosities lg (η_{A}/dPa*s)=5.0 and lg (η_{E}/dPa*s)=6.5.

It is for the skilled person to recognize that such precise viscosity values required both exact sensor detection of these viscosities, in particular through corresponding temperature measurements for the temperature of the glass ribbon 13 at the appropriate site, and also suitable measures for the removal and supply of thermal energy.

For this purpose, the temperature of the glass may be detected using sensor facilities or units 26, in which case these sensor units 26 do not only have to be disposed preferably close to the tweel 17 but may also be located at further sites, in particular along the section Hsl for the thickness-based hot forming, in order in particular to be able to detect the temperature of the glass ribbon 13 always with the necessary accuracy and to regulate it accordingly.

Appropriate supply of heat may be undertaken with overall local thermal control by means of the burners 4 and also by means of a float bath 7 with sector-specific temperature control.

Appropriate removal of heat may take place, for example, by special apparatuses for cooling such as fans, which are not represented in the figures but are known to the skilled person, or with cooling facilities 57, which may be suitably arranged along the section Hsl for the thickness-based hot forming. The sector-specific thermal control of the float bath 7 may also contribute to appropriate removal of heat.

Further, the amount of the glass 8 for hot forming, especially of the glass ribbon 13 formed from it, per unit time may be adjusted using the component for throughput regulation, more particularly the control slider or tweel 17, such that the temperature of the glass 8 for hot forming is always within a secure control range, which may be exceeded, for example, when the heat capacity of the glass with increasing throughput hinders temperature control only through the surface, owing to the increasing glass volume.

The method according to the present disclosure may for this purpose also be carried out, advantageously, such that a throughput of less than 400 t of glass per day, preferably less than 200 t of glass per day and more preferably less than 100 t of glass per day is obtained; for ascertaining the throughput, the basis used is the amount of glass which is conveyed per unit time through the component for throughput regulation, more particularly the control slider or tweel 17.

### LIST OF REFERENCE SIGNS

1 Float plant
2 Melting vessel
3 Batch for melting, especially glass batch
4 Burner
5 Glass melt
6 Channel
7 Float bath
8 Glass for hot forming
9 Float bath furnace
10 Overhead heater
11 Spout
12 Top roller
13 Glass ribbon
14 Lehr
15 Overhead and floor heater
16 Melting facility
17 Component for throughput regulation, especially control slider or tweel
18 Facility for defined adjustment of the viscosity of the molten glass 8 for hot 18 forming ahead of the component for throughput regulation 17
19 Chamber which is separated from the melting vessel 2 or else may form a part of said vessel and accommodates the molten glass 8, intended for shaping to a glass ribbon 13, for the defined adjustment of its viscosity
20 Region traversed by fluid flow 20
21 Region traversed by fluid flow
22 Wall of chamber 19
23 Wall of chamber 19
24 Wall of chamber 19
25 Wall of chamber 19
26 Sensor facility or unit
27 Bay or vessel section 1
28 Bay or vessel section 2
29 Bay or vessel section 3
30 Bay or vessel section 4
31 Bay or vessel section 5
32 Bay or vessel section 6
33 Glass sheet, also with reference signs 33′ or 33″
34 Top side of glass sheet 33
35 Bottom side of glass sheet 33
36 Surface of top side 34 of glass sheet 33
37 Surface of bottom side 35 of glass sheet 33
38 Top roller
39 Top roller
40 Top roller
41 Top roller
42 Top roller
43 Top roller
44 Top roller
45 Wall of channel 6
46 Wall of channel 6
47 Facility or apparatus for hot forming
48 Upper surface, upper principal surface of the glass ribbon 13 or glass 8 for hot forming
49 Lower surface, lower principal surface of the glass ribbon 13 or glass 8 for hot forming
50 Axis of symmetry
51 Axis of symmetry
52 Perpendicular in negative z-direction
53 Perpendicular in negative z-direction
54 Site of entry of the glass 8 into the section Hs for thickness-based hot forming, represented with a dashed line
55 Site of emergence of the glass 8 from the hot-forming section Hs
56 Distance from the component for throughput regulation at which the glass after impinging on the float bath has acquired its maximum width
57 Further cooling facility
M1 to M8 Area or measurement area for determining the fine waviness of the upper surface 48 of the glass ribbon 13 and the upper surface 36 of the top side 34 of the glass sheets 33, 33′, 33″
M1′ to M8′ Area or measurement area for determining the fine waviness of the lower surface 49 of the glass ribbon 13 and the surface 37 of the bottom side 35 of the glass sheets 33, 33′, 33″
ML Measurement line with a length of 260 mm, disposed respectively within a measurement area M1 to M8 or within a measurement area M1′ to M8′
Mi Midpoint of the glass ribbon in X-direction
Mt1 Boundary line to the region of the respective surface of the glass ribbon 13 that is covered by the top rollers 38 to 44
Mt2 Boundary line to the region of the respective surface of the glass ribbon 13 that is covered by the top rollers 38 to 44
OSG Line at a fine waviness value of 26 nm
η Viscosity
   η_{A} Viscosity at a distance from the component for throughput regulation at which the glass after impinging on the float bath has acquired its maximum width
   η_{E} Viscosity at the end of hot forming

1-15. (canceled)

16. A glass sheet, comprising:
a borosilicate glass having a thickness of between at least 0.7 mm and at most 7 mm, comprising a top side and a bottom side, characterized by a fine waviness on at least one surface of the top side or bottom side of the glass sheet of 10 nm to 26 nm in at least one direction parallel to a surface of the glass sheet.

17. The glass sheet of claim 16, wherein the thickness is between 1.1 mm and at most 7 mm.

18. The glass sheet of claim 17, wherein the thickness is at least 1.75 mm.

19. The glass sheet of claim 16, wherein the fine waviness on the at least one surface of the top side or bottom side of the glass sheet is measured along a line having a length of 260 mm.

20. The glass sheet of claim 19, wherein the fine waviness is measured within a square area of 260 mm times 260 mm.

21. The glass sheet of claim 16, wherein the glass sheet is formed by hot forming and the at least one direction corresponds to a direction perpendicular to a drawing direction used in hot forming of the glass sheet.

22. The glass sheet of claim 16, wherein the borosilicate glass comprises the following components in % by weight:

| | |
|---|---|
| SiO₂ | 70 to 87; preferably 75 to 85 |
| B₂O₃ | 5 to 25; preferably 7 to 14 |
| Al₂O₃ | 0 to 5; preferably 1 to 4 |
| Na₂O | 0.5 to 9; preferably 0.5 to 6.5 |
| K₂O | 0 to 3; preferably 0.3 to 2.5, more preferably to 2 |
| CaO | 0 to 3; and |
| MgO | 0 to 2. |

23. The glass sheet of claim 22, wherein the borosilicate glass comprises the following components in % by weight:

| | |
|---|---|
| SiO₂ | 75 to 85; |
| B₂O₃ | 7 to 14; |
| Al₂O₃ | 1 to 4; |
| Na₂O | 0.5 to 6.5; |
| K₂O | 0.3 to 2.5; |
| CaO | 0 to 3; and |
| MgO | 0 to 2. |

24. A set of glass sheets, comprising:
a plurality of glass sheets, each of the glass sheets comprising a borosilicate glass having a thickness of between at least 0.7 mm and at most 7 mm, comprising a top side and a bottom side, characterized by a fine waviness on at least one surface of the top side or bottom side of the glass sheet of 10 nm to 26 nm in at least one direction parallel to a surface of the glass sheet, wherein a median of the fine wavinesses of the set of glass sheets has a value which is less than 20 nm.

25. The set of glass sheets of claim 24, wherein the plurality of glass sheets comprises at least eight glass sheets.

26. A method for producing a glass sheet, the glass sheet comprising a borosilicate glass having a thickness of between at least 0.7 mm and at most 7 mm and comprising a top side and a bottom side, characterized by a fine waviness on at least one surface of the top side or bottom side of the glass sheet of 10 nm to 26 nm in at least one direction parallel to a surface of the glass sheet, the method comprising:
providing a batch comprising glass raw materials;
melting the batch to give a glass melt;
adjusting a viscosity of the glass melt;
transferring the glass melt to an apparatus for hot forming by floating glass on a float bath to form a glass ribbon; and
singulating the hot-formed glass ribbon to give a glass sheet, wherein the viscosity in the apparatus for hot forming is adjusted such that a sum total of common logarithms of a viscosity at a distance from a component for throughput regulation at which the glass after impinging on the float bath has acquired its maximum width and of a viscosity at an end of hot forming is between at least 11.4 and at most 11.8.

27. The method of claim 26, wherein the viscosity in the apparatus for hot forming is adjusted such that the sum total of the common logarithms of the viscosity at the distance from the component for throughput regulation at which the glass after impinging on the float bath has acquired its maximum width and of the viscosity at the end of hot forming is between at least 11.4 and at most 11.6.

28. The method of claim 26, wherein the common logarithm of the viscosity at the distance from the component for throughput regulation at which the glass after impinging on the float bath has acquired its maximum width is at least 5.0 and the common logarithm at the end of hot forming is at least 6.2.

29. The method of claim 28, wherein the common logarithm of the viscosity at the distance from the component for throughput regulation at which the glass after impinging on the float bath has acquired its maximum width is less than 5.25 and the common logarithm at the end of hot forming is at most 6.5.

30. The method of claim 28, wherein the common logarithm of the viscosity at the distance from the component for throughput regulation at which the glass after impinging on the float bath has acquired its maximum width is at least 5.1 and the common logarithm at the end of hot forming is at least 6.35.

31. The method of claim 26, wherein a difference between the common logarithms of the viscosity at the distance from the component for throughput regulation at which the glass after impinging on the float bath has acquired its maximum width and of the viscosity at the end of hot forming is between at least 1.25 and at most 1.5.

32. The method of claim 31, wherein the difference is between at least 1.25 and at most 1.45.

33. The method of claim 26, wherein a throughput of less than 400 t of glass per day is obtained.

34. The method of claim 26, wherein the at least one direction is indicated on the glass sheet or on packaging of the glass sheet.
